(19) United States
(12) Patent Application Publication
(10) Pub. No.: US 2006/0021583 A1
(43) Pub. Date: Feb. 2, 2006

(54) Pet bed including replaceable material

(75) Inventor: Chris Jakubowski, Rutland, VT (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Vermont Juvenile Furniture, d/b/a Pet Gear Inc., West Rutland, VT (US)

(21) Appl. No.: 10/909,682

(22) Filed: Aug. 2, 2004

(51) Int. Cl. A01K 1/035

(52) U.S. Cl. 119/28.5

(57) ABSTRACT

A multi-layer pet bed that includes a replaceable bedding material, such as cedar chips, in a selected layer which is spaced from the pet by another layer of the bed. An opening is formed in the bed cover for access to at least the replaceable material.

### FIELD OF INVENTION

The present invention relates to a multi-layer pet bed. More particularly the present invention relates to a multi-layer pet bed having replaceable bedding material. Most particularly the present invention relates to a multi-layer pet bed having replaceable bedding material that is deodorizing and insect repelling.

### BACKGROUND

Pet beds have been in use for many years for providing domestic animals, such as dogs and cats, a resting or sleeping area. A problem often associated with such beds is that, after a period of use, the beds can become foul smelling and infested with insects, such as fleas and mites.

Although pet beds have been provided with removable covers which can be washed and reused, the underlying padding or mattress is generally not easily cleaned or refreshed. Accordingly, the entire padding or mattress may need to be replaced at considerable cost.

In bedding constructed with a deodorizing or insect repelling filler material, it is often necessary purchase a replacement for the entire padding and/or filler material. Additionally, the deodorizing and insect repelling capabilities of such fillers greatly diminish over a period of time.

Accordingly, a need exists for a pet bed with replaceable bedding material having deodorizing and insect repelling capabilities without adversely impacting the primary purpose of being a comfortable resting area for the pet.

### SUMMARY

A multi-layer pet bed having at least an upper support layer, a lower support layer a portion of which is replaceable material, a first cover that encloses at least the replaceable material; and, a second cover that encloses both the upper and lower layers and includes an opening that provides access to the replaceable material.

A multi-layer pet bed having at least an upper support layer of a first predetermined compression resistance, a lower support layer a portion of which is replaceable material that has a second predetermined compressive resistance, and a cover that encloses the upper and lower layers and includes an access opening to the replaceable material.

### BRIEF DESCRIPTION OF THE DRAWING(S)

In the drawings:

FIG. 1 is a perspective view of a first embodiment of a pet bed constructed in accordance with the present invention;

FIG. 2 is a sectional view of the bed of FIG. 1 taken along section line 2-2 of FIG. 1;

FIG. 3 is a bottom perspective view of a second embodiment of a pet bed constructed in accordance with the present invention;

FIG. 4 illustrates a third embodiment of a pet bed constructed in accordance with the present invention; and

FIG. 5 illustrates a fourth embodiment of a pet bed constructed in accordance with the present invention.

### DETAILED DESCRIPTION OF THE PREFERRED EMBODIMENT(S)

The present invention will now be described in conjunction with the drawings wherein like numerals indicate like elements. In each of the preferred embodiments, the bed comprises at least a first layer which is the primary pet support layer and a second layer which includes a replaceable portion which is preferably cedar wood chips. A particular advantage of this material is that cedar wood chips serve as both a deodorant and an insect repellant, are relatively inexpensive and are also soft and comfortable.

With reference to FIG. 1, there pet bed 10 includes an outer cover 12 which has a pet contact surface 13. Preferably, the pet contact surface 13 is of an air permeably material for animal comfort. However, pet contact surface 13 may be made of synthetic materials or leather that has micro perforations in order to permit air permeability. The thickness 14 and length 16 of the pet bed 10 will be determined generally by the size of the pet. Obviously, larger and heavier pets may require larger sleeping areas and it may be preferable to provide a greater thickness 14. The pet bed 10 optionally includes a handle 18 for ease of carrying.

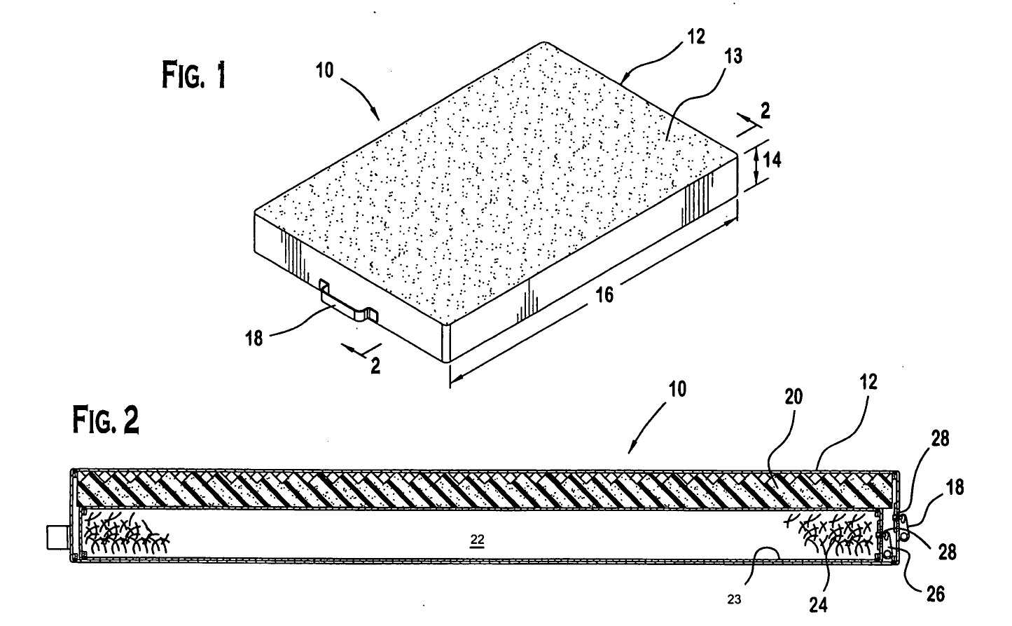

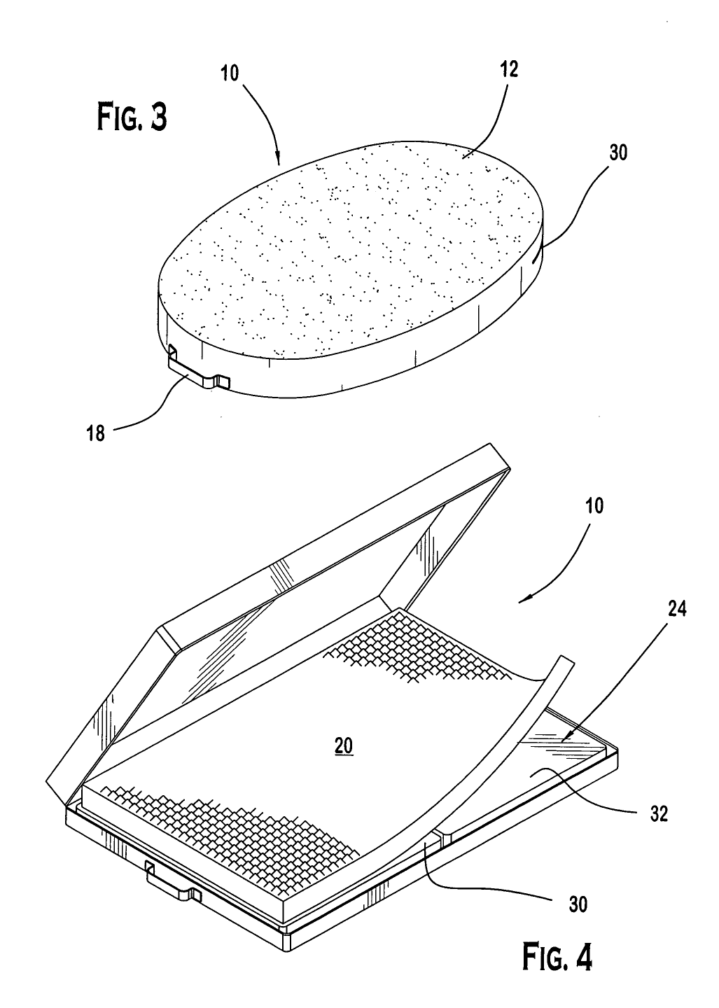

With reference to FIG. 2, the interior of the pet bed 10 is comprised of a first layer 20, which is preferably an egg crate foam of the type that is common for bedding, and a separate lower layer 22. One egg crate foam suitable for the first layer 20 is the type frequently used for furniture of bedding application. It is generally preferred that the foam be approximately two inches thick. The material in the lower layer 22 is preferably a material 24 having a compressive resistance different than first layer 20. This is in a manner similar to a box spring and a mattress, however, the lower layer 22 does not need to have the structure or stiffness usually associated with a box spring. Rather, it is intended to convey the different characteristics of the multiple layers. Pet bed 10 preferably includes an interior cover 23 over the lower layer 22 which is preferably comprised of a loose, replaceable deodorizing material. Most preferably, the material 24 also has insect repellent qualities. Such a material, as previously noted, is commonly available as cedar wood chips which are presently preferred to be provided in about a two inch layer. If desired, the cover 23 may be eliminated and the replaceable material 24 may be distributed to form lower layer 22 directly within the lower portion of the outer cover 12. However, it has been found advantageous to have the replaceable material within a permeable second cover for ease of removal. In addition, the second cover has been found to assist in preventing the material 24, wood chips, from becoming embedded in the material of the first layer, especially when it is somewhat porous, like the foam egg crate layer 20 which is preferred at this time. With reference to FIG. 2, the lower layer cover 23 preferably includes the handle 26. In the preferred embodiment, both covers include an access opening 28 which may be closed by a zipper or hook and pile material commonly known as Velcro®, see 30 of FIG. 3.

With reference to FIG. 4, there is shown a pet bed 10 having the support layer 20 and the lower layer 22 which is separated into portions 30 and 32. As illustrated, portions 30 and 32 are each about one half of the lower support layer 24. With this configuration, the pet owner has the option of using replaceable material in one or both of the portions 30 and 32. Thus, FIG. 4 illustrates the flexibility of the present invention in allowing for selective placement of the replaceable material.

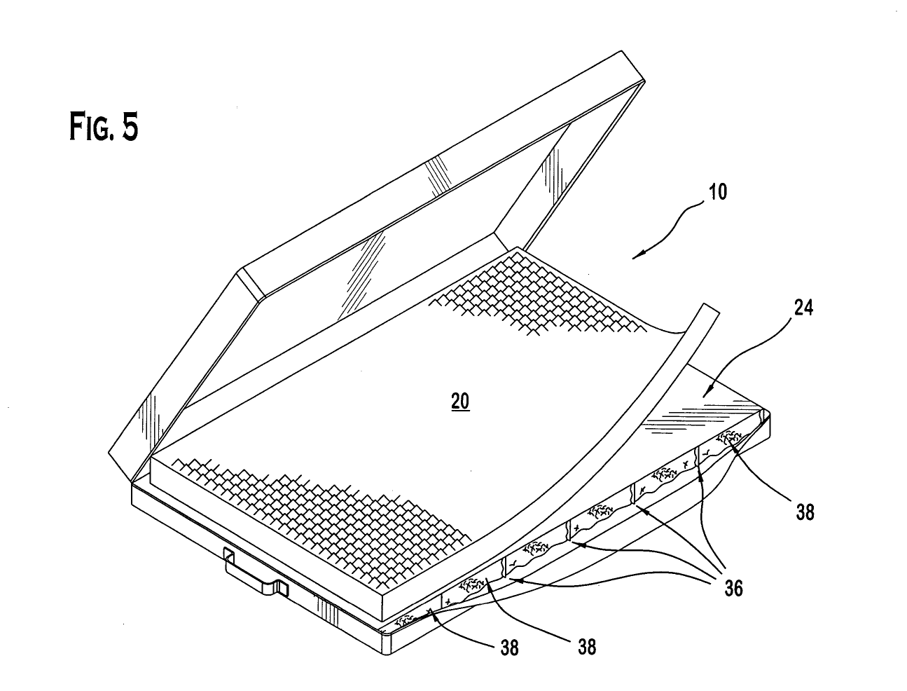

With respect to FIG. 5, there is illustrated an embodiment which is of particular value with larger pets. In the embodiment of FIG. 5, the pet bed 10 has a lower support layer 24 which includes a plurality of vertical dividers 36 that create a number of pockets or sleeves 38 that receive replaceable material. With this embodiment, replaceable material in each sleeve 38 may be the same or may be selected for different characteristics. In addition to providing that advantage, the dividers 36 help to prevent undesirable migration in material through pet movements by retaining it within the individual sleeve 38.

From the above description, it will be understood whether they are skilled in the art that various configurations of a multi-layer pet bed which will exhibit the advantages of the present invention.

1. A pet bed, comprising:
an upper support layer;
a lower support layer that is comprised of replaceable material presented in a single layer;
a single cover that encloses the entirety of the replaceable material; and,
a second cover that encloses both the upper and lower layers and includes an opening that provides access to the layer of replaceable material.

2. The pet bed of claim 1 wherein the replaceable material is cedar.

3. The pet bed of claim 1 wherein the upper and lower layers are generally equal in area.

4. The pet bed of claim 3 wherein the replaceable material is cedar.

5. The pet bed of claim 1 wherein the upper layer is a foam material and the lower layer is comprised partly of foam material and partly of replaceable material.

6. The pet bed of claim 5 wherein the replaceable material is cedar.

7. The pet bed of claim 1 wherein the single cover is a permeable fabric.

8. The pet bed of claim 7 wherein the first cover defines at least two compartments.

9. The pet bed of claim 7 wherein the replaceable material is cedar.

10. The pet bed of claim 9 wherein the first cover defines at least two compartments.

11. The pet bed of claim 7 wherein the upper and lower layers are generally equal in area.

12. The pet bed of claim 11 wherein the first cover defines at least two compartments.

13. The pet bed of claim 12 wherein the replaceable material is cedar.

14. The pet bed of claim 11 wherein the replaceable material is cedar.

15. The pet bed of claim 1 wherein the single cover is permeable.

16. The pet bed of claim 15 wherein the single cover includes an access opening.

17. The pet bed of claim 16 wherein the access opening includes a zipper.

18. The pet bed of claim 15 wherein the second cover is permeable.

19. (canceled)

20. The pet bed of claim 18 wherein the first and second cover access openings each include a zipper.

21. A multi-layer pet bed, comprising:
a foam support layer;
a lower support layer positioned beneath the foam support layer, that is comprised essentially of replaceable material; and,
a single cover that encloses both layers.

22. The pet bed of claim 21 further comprising a second cover that encloses the replaceable material.

23. The pet bed of claim 21 wherein the replaceable material is cedar wood.

24. The pet bed of claim 23 further comprising a second cover that encloses the cedar wood.

25. The pet bed of claim 21 wherein the replaceable material comprises cedar wood chips.

26. The pet bed of claim 21 wherein the foam support layer is egg crate foam.

27. The pet bed of claim 26 wherein the replaceable material is cedar wood.

28. The pet bed of claim 27 further comprising a second cover that encloses the cedar wood.

29. A pet bed, comprising:
an upper support layer having a predetermined compression resistance;
a lower support layer having a second predetermined compression resistance with at least a portion thereof being comprised of replaceable material; and
a single cover that encloses the upper and lower layers and includes an access opening to the replaceable material.

30. The pet bed of claim 29 further comprising a second cover that encloses the replaceable material.

31. The pet bed of claim 29 wherein the replaceable material is cedar wood.

32. The pet bed of claim 31 further comprising a second cover that encloses the cedar wood.

33. The pet bed of claim 29 wherein the replaceable material comprises wood chips.

34. A pet bed, comprising:
an upper layer having a predetermined level of support under compression;
a lower layer having a second predetermined level of support under compression with a portion thereof being comprised of replaceable material; and
a single cover that encloses the upper and lower layers and includes an access opening to the replaceable material.

35. The pet bed of claim 34 further comprising a second cover that encloses the replaceable material.

36. The pet bed of claim 34 wherein the replaceable material is cedar wood.

37. The pet bed of claim 36 further comprising a second cover that encloses the cedar wood.

38. The pet bed of claim 34 wherein the upper and lower layers are of substantially the same thickness.
